(19) United States
(12) Patent Application Publication
(10) Pub. No.: US 2026/0314875 A1
(43) Pub. Date: Oct. 15, 2026

(54) MULTI-FUNCTION GRILLS

(71) Applicant: Sensio, Inc., New York, NY (US)

(72) Inventors: Jorge B. Garcia, Rogers, AR (US); Sébastien Préseault-Céré, Montréal (CA)

(73) Assignee: Sensio, Inc., New York, NY (US)

(21) Appl. No.: 19/464,987

(22) Filed: Jan. 30, 2026

Related U.S. Application Data
(60) Provisional application No. 63/752,077, filed on Jan. 31, 2025.

(51) Int. Cl. A47J 37/06

(52) U.S. Cl. CPC A47J 37/0676

(57) ABSTRACT

A multi-function grill, comprising a base unit, a grill plate positioned on the base unit, a reflector disposed beneath the grill plate, the reflector and the grill plate forming a sealed heated chamber between the reflector and the grill plate, at least one heating element positioned within the sealed heated chamber, and a control panel for adjusting cooking temperature.

### RELATED APPLICATIONS

This application claims the benefit of, and priority to, U.S. Provisional Patent Application Ser. No. 63/752,077, filed Jan. 31, 2025, the disclosure of which is hereby incorporated, by reference, in its entirety.

### BACKGROUND OF THE INVENTION

### FIELD OF THE INVENTION

Embodiments relate to multi-function grills.

### DESCRIPTION OF THE RELATED ART

Conventional grills and cooking appliances often suffer from several limitations that impact their performance and user experience. Many traditional grills struggle to achieve and maintain high, uniform temperatures across the cooking surface, leading to inconsistent cooking results. Heat distribution can be uneven, creating hot and cold spots that make it challenging to cook food properly. Additionally, these devices frequently lack versatility, being limited to a single cooking function or requiring separate attachments for different cooking methods. Energy efficiency is another common issue, with heat loss and poor insulation resulting in longer preheating times and increased energy consumption. Furthermore, many existing grills are bulky and difficult to store, making them impractical for users with limited space. The inability to quickly adjust cooking temperatures or switch between different cooking styles also limits the culinary possibilities for users. These shortcomings in current grill designs create a need for more advanced, multi-functional cooking appliances that can address these issues and provide a more efficient, versatile, and user-friendly cooking experience.

### SUMMARY OF THE INVENTION

Multi-function grills are disclosed. This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an embodiment, a multi-function grill may include a base unit; a grill plate positioned on the base unit; a reflector disposed beneath the grill plate, the reflector and the grill plate forming a sealed heated chamber between the reflector and the grill plate; at least one heating element positioned within the sealed heated chamber; and a control panel for adjusting cooking temperature.

In one embodiment, the multi-function grill may also include a lid unit.

In one embodiment, the lid unit may be attached to the base unit by a hinge mechanism, the base unit and the lid unit attached to the base unit by the hinge mechanism are configured to accommodate a plurality of removable grill plates each having different physical dimensions.

In one embodiment, the grill plate may include a groove along its perimeter and the reflector may include a step, the groove and the step configured to engage with each other to form the sealed heated chamber.

In one embodiment, the at least one heating element may include at least one of an infrared heating element, a halogen heating element or a resistive heating element.

In one embodiment, the reflector may include a grill seat configured to support the grill plate at a predetermined distance from the at least one heating element, and the base unit may include a reflector seat configured to support the reflector.

In one embodiment, the at least one heating element may include an infrared heating element comprising a tubular structure with a filament positioned at a center and an inner surface coated with a reflective material, the reflective material configured to direct infrared radiation towards the grill plate.

In one embodiment, an underside surface of the grill plate facing the at least one heating element may include a radiation absorbent material.

In one embodiment, the multi-function grill may also include a transparent protection plate between the least one heating element and the grill plate.

According to another embodiment, a multi-function grill may include: a base unit comprising: a grill plate positioned on the base unit, a reflector disposed beneath the grill plate, the reflector and the grill plate forming a sealed heated chamber between the reflector and the grill plate, and at least one heating element positioned within the sealed heated chamber; a lid unit comprising: a lid grill plate positioned on the lid, a lid reflector disposed beneath the lid grill plate, the lid reflector and the lid grill plate forming a lid sealed heated chamber between the lid reflector and the lid grill plate, and at least one lid heating element positioned within the lid sealed heated chamber; and a control panel for controlling the at least one heating element and the at least one lid heating element to adjust cooking temperature.

In one embodiment, the lid unit may be attached to the base unit by a hinge mechanism, the lid unit attached to the base unit by the hinge mechanism configured to accommodate a plurality of removable grill plates each having different physical dimensions.

In one embodiment, the plurality of removable grill plates comprise at least one of waffle making plates, panini pressing plates and slow cooking plates.

In one embodiment, the plurality of removable grill plates are attached to the base unit and lid unit by respective clip mechanisms.

In one embodiment, the grill plate and the lid grill plate each comprise a groove along their perimeter and the reflector and lid reflector each comprise a step, the grooves and steps configured to engage with each other to form the sealed heated chamber and the lid sealed heated chamber.

In one embodiment, the grooves of the grill plate and the lid grill plate and the steps of the reflector and lid reflector create metal-to-metal seals when engaged.

In one embodiment, the at least one heating element and the at least one lid heating element are each at least one of an infrared heating element, a halogen heating element or a resistive heating element.

In one embodiment, the reflector may include a grill seat configured to support the grill plate at a predetermined distance from the at least one heating element, and the base unit may include a reflector seat configured to support the reflector, and wherein the lid reflector may include a lid grill seat configured to support the lid grill plate at a predetermined distance from the at least one lid heating element, and the lid unit may include a reflector seat configured to support the lid reflector.

In one embodiment, the at least one heating element and the at least one lid heating element each comprise an infrared heating element comprising a tubular structure with a filament positioned at a center and an inner surface coated with a reflective material, the reflective material configured to direct infrared radiation towards the grill plate and the lid grill plate respectively.

In one embodiment, an underside surface of the grill plate facing the at least one heating element and an underside surface of the lid grill plate facing the at least one lid heating element comprise a radiation absorbent material.

In one embodiment, the multi-function grill may also include a transparent protection plate between the least one heating element and the grill plate.

The foregoing general description of the illustrative embodiments and the following detailed description thereof are merely exemplary aspects of the teachings of this disclosure and are not restrictive.

### BRIEF DESCRIPTION OF THE DRAWINGS

For a more complete understanding of the present invention, the objects and advantages thereof, reference is now made to the following descriptions taken in connection with the accompanying drawings in which:

FIGS. 1A and 1B illustrate assembled and exploded views of a grill base portion, according to aspects of the present disclosure.

FIGS. 2A, 2B and 2C depicts an exploded view of a grill base portion and folded configurations, according to aspects of the present disclosure.

FIGS. 3A, 3B, and 3C show isometric views of different cooking plate types for a multi-function cooking appliance, according to aspects of the present disclosure.

FIGS. 4A and 4B illustrates isometric views of a multi-function grill device with different heater types, according to aspects of the present disclosure.

FIGS. 5A and 5B depict multiple views of a grill device with a foldable design, according to aspects of the present disclosure.

FIGS. 6A and 6B show multiple views of a grill with a drip tray in folded and unfolded configurations, according to aspects of the present disclosure.

FIGS. 7A and 7B illustrates a close-up section view of a heated chamber and seal in a cooking device, according to aspects of the present disclosure.

FIGS. 8A and 8B depict a sectional view of an infrared heating system for a cooking appliance, according to aspects of the present disclosure.

FIG. 9 shows a section view of a grill assembly focusing on a sealing mechanism, according to aspects of the present disclosure.

FIGS. 10A and 10B illustrates orthogonal front views of a grill control panel with different configurations, according to aspects of the present disclosure.

FIGS. 11A and 11B depict orthogonal side views of a grill in various positions and vertical storage, according to aspects of the present disclosure.

FIG. 12 depicts a section view of a grill assembly having a separator plate, according to aspects of the present disclosure.

### DETAILED DESCRIPTION OF PREFERRED EMBODIMENTS

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a multi-function grill with optimized heat distribution and versatile cooking capabilities. The grill may incorporate design features to achieve high and uniform cooking temperatures, efficient heat retention, and adaptability for various cooking methods. In some aspects, the grill may utilize directional infrared heating to achieve desired temperatures uniformly across the cooking surface (e.g. the entire cooking surface). This performance may be achieved through engineering of heat flux, a specially designed heated chamber, and strategic use of reflective and absorbent surfaces.

The disclosed grill may include directional infrared heating elements arranged to efficiently heat the grill plate; a reflector that reflects heat towards the grill plate from below and on the side walls; and a groove and step seal between the reflector and the grill plate to trap heat in the heated chamber. These features may provide efficient heating of the grill plate while protecting the electronics in the base. The grill may also allow for rapid heating to sear meat at a high temperature, followed by quick cooling to cook meat at a lower temperature. Additional features may include a cooking surface capable of reaching uniform temperature; interchangeable cooking plates for different cooking styles; a multi-position hinged lid that may integrate heaters for additional cooking functions; advanced temperature control systems ranging from bi-metal thermostats to digital controls with temperature probes; and a lid for dual cooking functions. The grill may also feature a drip tray system for easy cleaning and a design that allows for dual cooking zones when fully opened.

It is noted that while infrared elements are described herein, the multi-function grill may utilize various types of heating elements beyond infrared heaters to provide versatile cooking options. These alternative heating elements may include halogen lamps, resistive heating coils, calrod elements, or other suitable heating technologies. Halogen heating elements may offer rapid heating and precise temperature control, while resistive heating coils may provide consistent and even heat distribution. Calrod elements, known for their durability and efficiency, may be employed for their ability to reach high temperatures quickly. The choice of heating element may depend on factors such as the desired cooking performance, energy efficiency requirements, and specific culinary applications. In some cases, the grill may incorporate a combination of different heating element types to optimize performance for various cooking methods. The flexibility to use different heating technologies may enhance the grill’s adaptability and allow for customization based on user preferences or regional energy considerations.

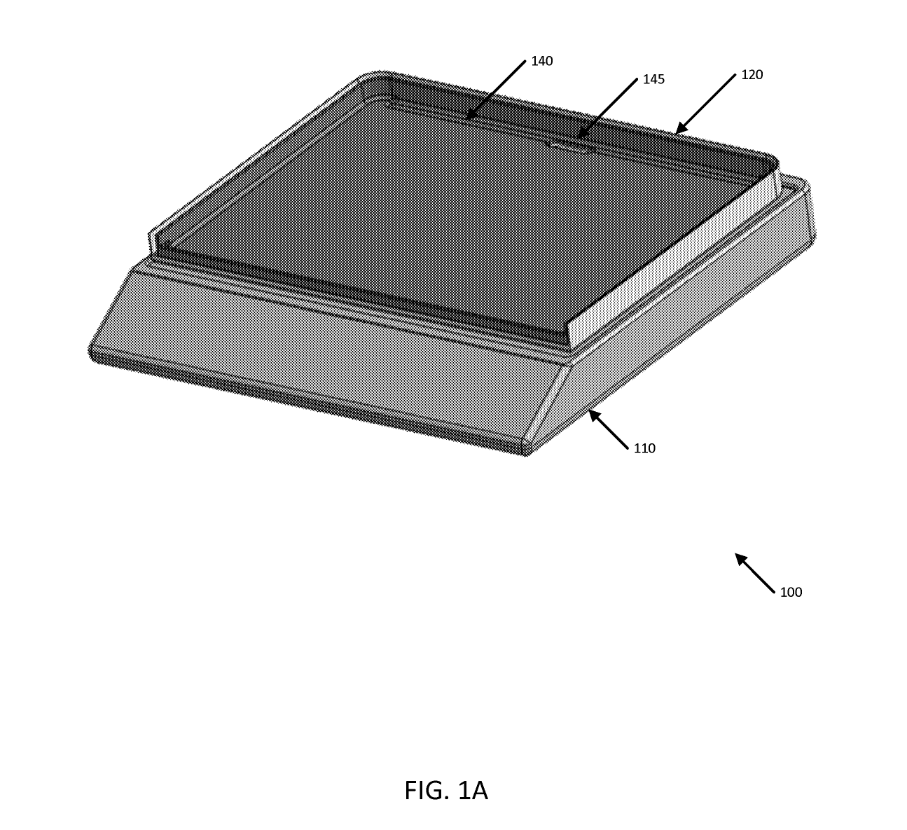

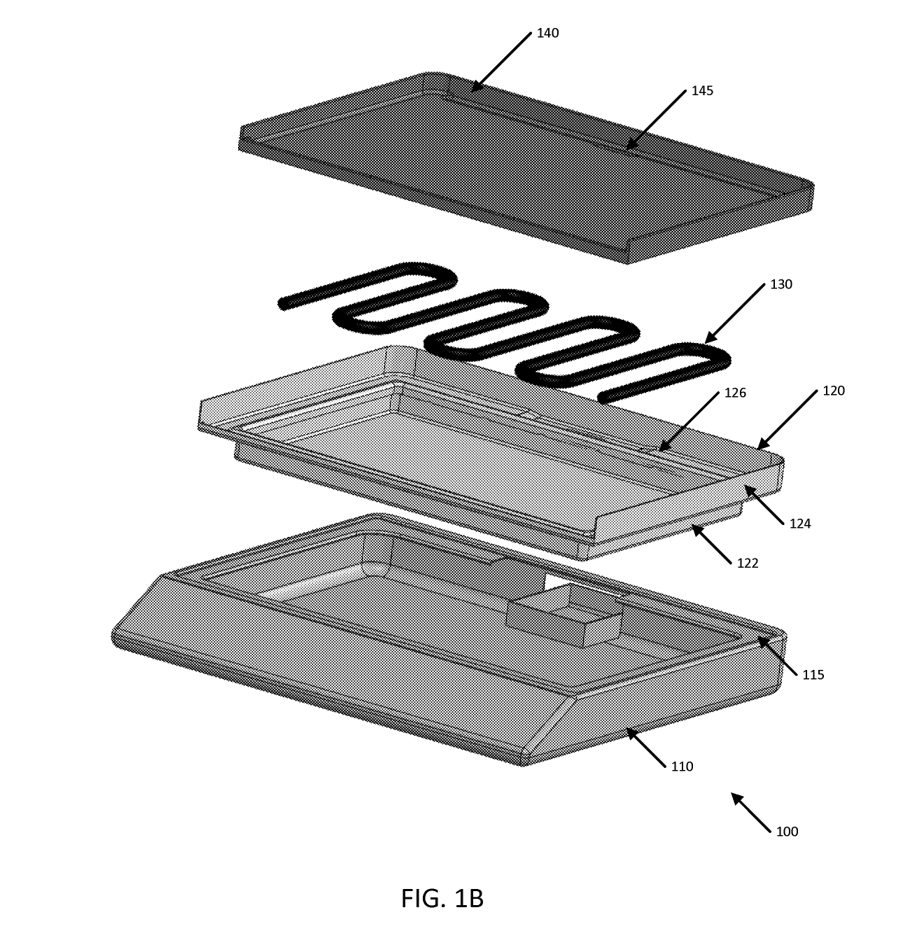

FIGS. 1A and 1B illustrate both an assembled and exploded view of a grill base portion 110 for a grill 100, showcasing the components and structure of the grill’s lower section 122. The grill base assembly 110 comprises several components that work together to create an efficient and high-performance cooking surface.

The grill base assembly 110 includes a grill plate 140, which serves as the primary cooking surface. Beneath the grill plate is a reflector 120, designed to redirect heat towards the cooking surface and enhance overall heat distribution. The reflector 120 covers surfaces under and around the plate perimeter, as well as surrounding the heating element 130. This configuration helps to increase (e.g. maximize) heat efficiency and maintain consistent cooking temperatures across the grill plate 140.

Grill plate 140 may include one or more drip holes 145 that may allow for juices to drain away from food being cooked.

In the exploded view, the arrangement of components is visible. The grill plate 140 sits atop the reflector 120, which in turn is positioned above the base section 110. The reflector 120 includes a grill plate support rim 126 on which the grill plate 140 rests. The upper section 124 of the reflector 120 holds the grill plate 140, while the lower section 122 forms a heating chamber that houses the infrared heating element 130, shown as a serpentine structure in this example. The base section 110 includes a reflector support rim 115 on which the upper section of the reflector 120 sits, providing a stable foundation for the assembly.

The grill plate 140 and the reflector 120 are designed to create a sealed heated chamber. This is achieved through a groove in the grill plate 140 and a corresponding step on the reflector 120, which fit together to minimize heat loss and improve cooking efficiency. Details of this seal are described in later figures. In some cases, the grill plate 140 and reflectors 120 may be fixed in place, while in other implementations, they may be removable for easy cleaning or replacement.

To further enhance heat absorption and efficiency, the underside of the grill plate 140 may be made of a naturally absorbent material, or may be coated with a radiation-absorbent color. This coating helps to increase (e.g., maximize) heat retention and transfer from the infrared heating element 130 to the cooking surface.

The modular construction of the grill base assembly 110 facilitates easy assembly and disassembly. In some cases, this design may allow for the interchange of components, such as different grill plates 140 for various cooking functions, enhancing the versatility of the grill 100.

The design of the grill base assembly 110 focuses on efficient heat transfer from the heating element 130 to the grill plate 140, with the reflector 120 playing a role in enhancing heat distribution and retention. This configuration aims to provide a uniform cooking surface temperature, which is essential for consistent and high-quality grilling results.

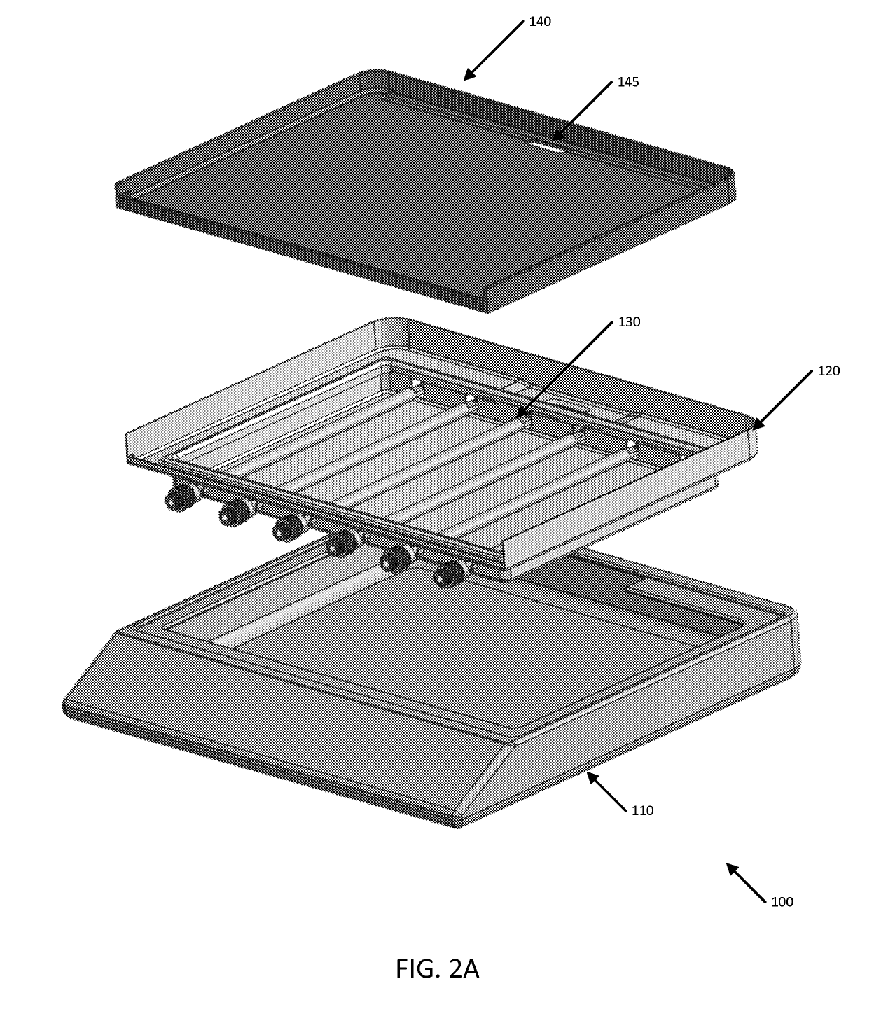

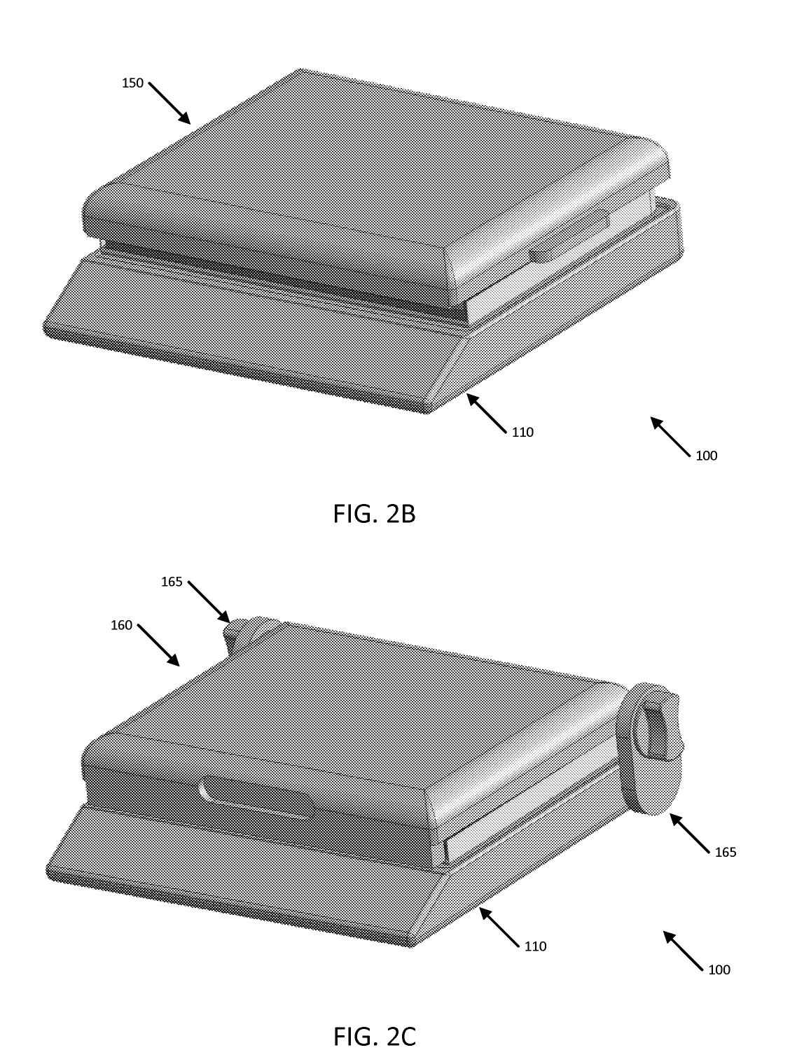

FIGS. 2A, 2B, and 2C,illustrate an exploded view of a grill base portion 110 and various configurations of the grill in folded positions. FIG. 2A shows the main components of the grill base 110. At the top is the grill plate 140, which appears to be a flat, rectangular cooking surface. Below the grill plate is the reflector 120, a component designed to redirect heat from infrared heaters. The reflector 120 sits atop the base 110, which forms the bottom of the grill assembly 100. Within the base 110, multiple heating element 130 are visible, arranged in parallel tubes. As shown in FIG. 2A, the design may be an open grill without a lid, or as shown in FIG. 2B, may have a lid 150 with similar features

Specifically, in FIGS. 2B, and 2C, different lid configurations are depicted. For example, a detached lid 150, which can be completely removed from the grill base. Below that is a hinged lid 160, connected to the base at one end. The hinged lid 160 may be integrated into the grill 100, offering position control and the ability to hold the lid 160 open. This integration also allows for vertical storage of the grill 100, enhancing its space-saving capabilities.

The multi-position lid hinge 165 allows the lid 160 to be adjusted and held at various angles and heights relative to the grill base 110. This feature enhances the grill 100’s adaptability for various grill plate sizes/configurations, cooking needs and food sizes.

In some cases, the lids 150 or 160 may have an overlap to limit air flow out of the heating area. This design feature helps to maintain consistent cooking temperatures and improve overall energy efficiency. Additionally, an optional lid seal (not shown) may be added to further enhance heat retention and moisture control, particularly for cooking methods that require a more controlled environment.

This lid seal may be a compressible material such as a silicone element for enhanced sealing properties. The choice of sealing method may depend on factors such as the desired level of heat retention, manufacturing considerations, and maintenance requirements. The versatility of the lid configurations, combined with these sealing options, allows the grill 100 to accommodate a wide range of cooking techniques and preferences. Although not shown, it is noted that the grill lid 165 shown in FIG. 2B may include similar components (e.g. grill plate 140, reflector 120, heating elements e, etc.) as the main components of the grill base 110.

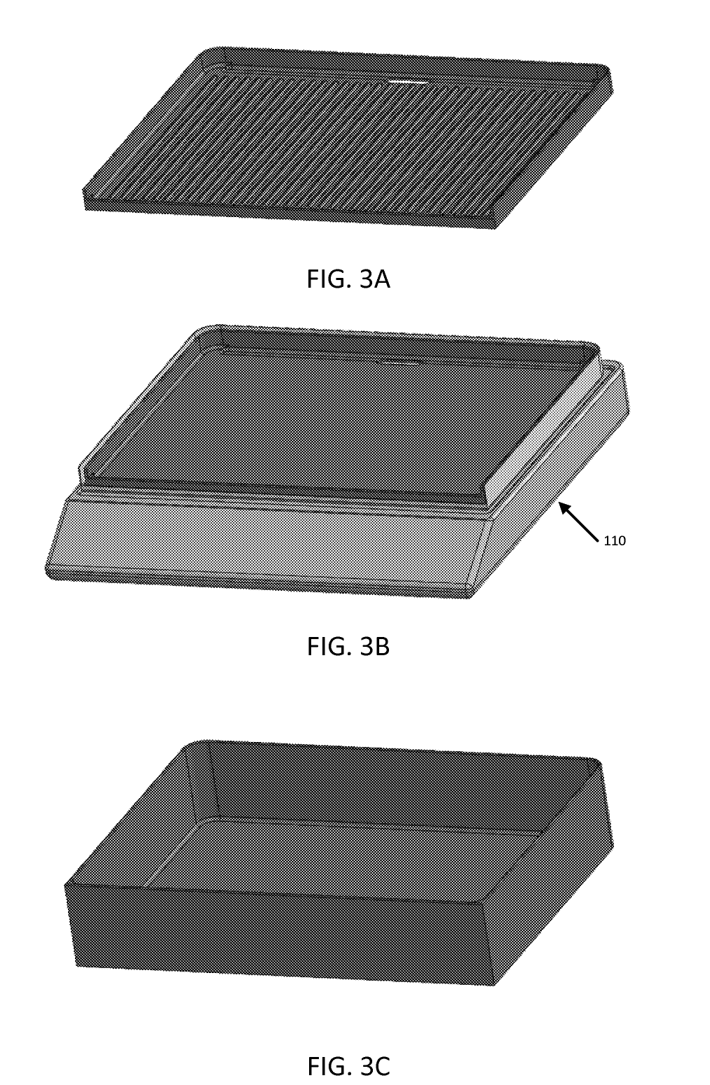

As shown in FIGS. 3A, 3B, 3C, the grill device may include interchangeable cooking plates, allowing for versatile cooking options to suit various culinary needs. These interchangeable plates may include a grill plate, a griddle plate, and a deep cooking plate, each designed for specific cooking methods and food types.

As shown in FIG. 3A, the grill plate may feature raised ribs across its surface, providing the characteristic grill marks on food and allowing fats and juices to drain away during cooking. In some cases, the grill plate may have variable thickness or heat flow ribs to optimize surface temperature distribution. This design may create different heat zones on the cooking surface, allowing for more precise control over the cooking process.

As shown in FIG. 3B, the griddle plate may have a smooth, flat surface ideal for cooking items such as pancakes, eggs, or sandwiches. This plate may provide even heat distribution across its surface, making it suitable for foods that require consistent cooking temperatures.

As shown in FIG. 3C, the deep cooking plate may have high sides, creating a container-like structure suitable for preparing foods that require more liquid or depth, such as stews or deep-frying. The deep plate allows for a wide range of cooking applications beyond traditional grilling or griddling.

These interchangeable plates may be removable from the grill base portion 110, allowing users to easily switch between different cooking styles using the same appliance. The ability to interchange plates may enhance the multi-functionality of the grill, enabling users to perform various cooking techniques without the need for multiple separate appliances. In some cases, additional plate designs may be available to further expand the grill’s cooking capabilities.

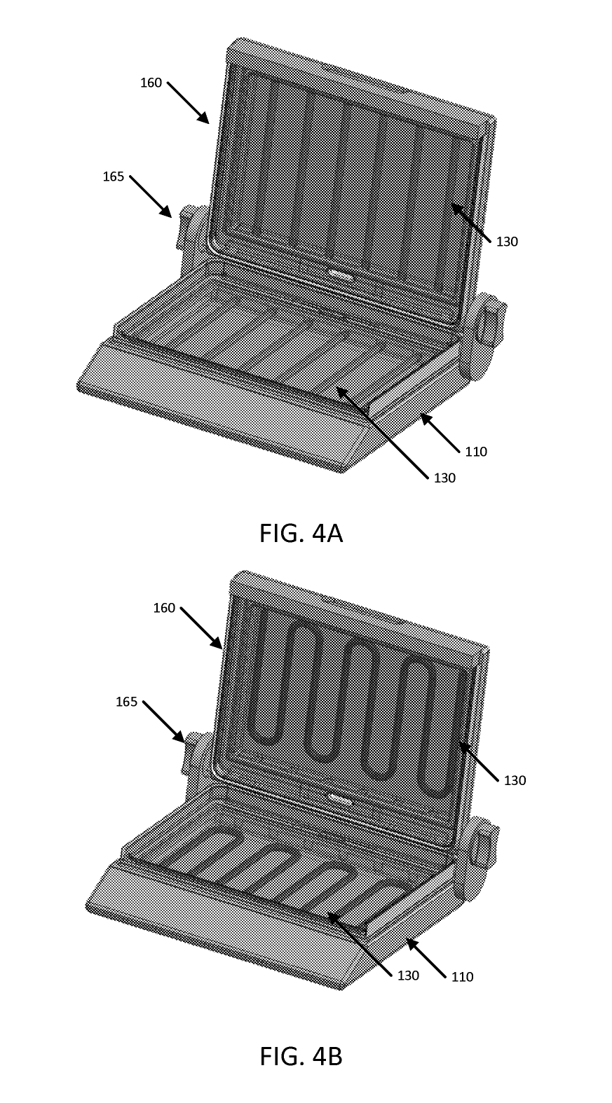

As shown in FIGS. 4A and 4B, the multi-function grill may incorporate various heater types and configurations to optimize cooking performance and versatility. In some cases, the grill may employ directional heating elements 130. These heating elements 130 may replace traditional heating methods to provide faster heat-up times and more precise temperature control. Directional infrared heating may allow for rapid searing of foods and quick temperature adjustments during cooking. The heating elements 130 may be arranged in parallel strips or in other configurations such as a serpentine configuration to optimize heat distribution across the cooking surface.

The grill may feature heating elements 130 in both the base and the lid, allowing for dual-sided cooking. This configuration may enable functions such as pressing sandwiches or searing meats from both top and bottom simultaneously. In some cases, the heating elements 130 in the base 110 and lid 160 may be independently controlled, allowing for different temperature zones or cooking methods on each surface. The ability to use different heater types and configurations enhances the grill’s adaptability for various cooking tasks and user preferences.

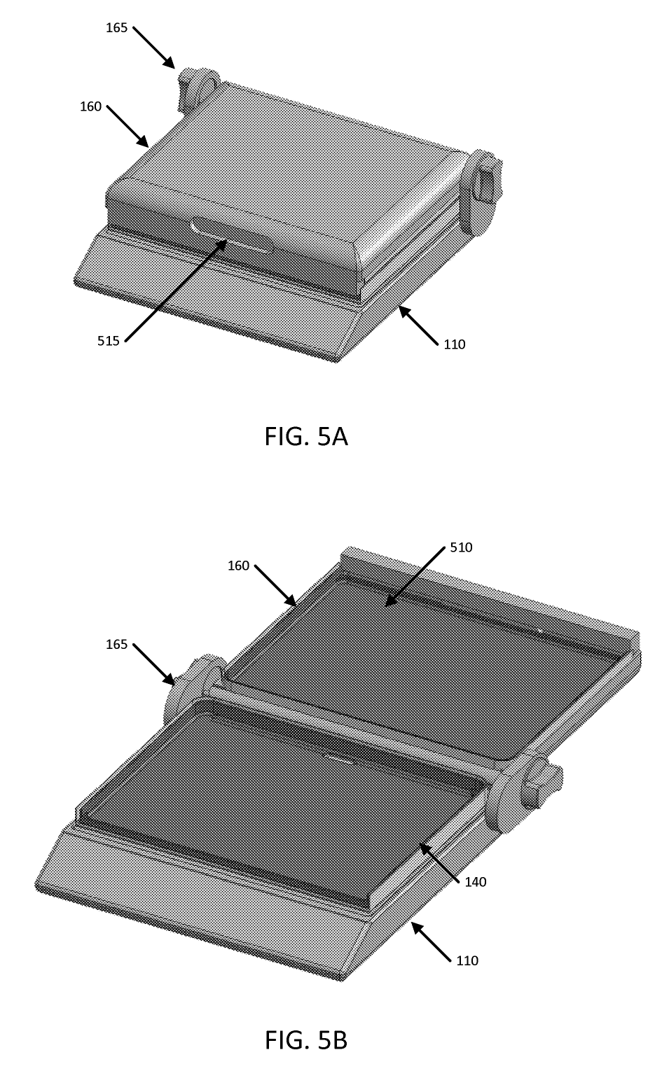

FIGS. 5A and 5B illustrate multiple views of a grill device with a foldable design, showcasing both folded (FIG. 5A) and unfolded positions (FIG. 5B). The grill comprises a base unit 110 and a hinged lid 160 connected by a hinge mechanism 165. In the folded position (FIG. 5A), the grill appears as a compact, closed unit with the hinged lid 160 sitting atop the base 110, creating a streamlined profile. A handle 515 is visible on the front edge of the hinged lid 160, facilitating easy opening.

The hinge mechanism 165, visible on both sides of the grill, is a notable feature. The hinge mechanism 165 may allow multi-height positioning of the lid, enhancing the grill’s adaptability for various cooking tasks. This multi-height capability is evident in the slight difference between the two folded views, where the hinged lid 160 may be positioned at different heights. In the unfolded position, the grill reveals two cooking surfaces – the base cooking plate 140 and the lid cooking plate 510. The base cooking 140 plate may remain in a fixed position, while the hinged lid 160 may unfold to create a second cooking surface. This configuration effectively doubles the available cooking area. The fold-out hinge mechanism may allow the hinged lid 160 to open fully and lock into place, creating two level cooking surfaces side by side.

The multi-position hinge 165 may provide additional versatility by accommodating grill plates of various depths and sizes. This feature may allow users to switch between flat grill plates for traditional grilling and panini pressing, shallow plates for items like pancakes or eggs, and deep plates for slow cooking or stews. The grill plates may be designed to seat securely on the reflector, ensuring proper heat distribution and retention. The multi-position hinge 165 may enable the hinged lid 160 to be adjusted to different heights above these interchangeable plates, maintaining optimal cooking conditions for each plate type. This adaptability may enhance the grill’s functionality, allowing it to serve as a multi-purpose cooking appliance suitable for a wide range of culinary techniques and recipes.

For example, panini plates may feature ridged surfaces on both the base cooking plate 140 and the lid cooking plate 510, allowing for the creation of distinctive grill marks on sandwiches. When using panini plates, the multi-position hinge 165 may allow users to adjust the lid height and pressure applied to the sandwich, accommodating various bread thicknesses and fillings. For slow cooking plates, which may be deeper to hold larger volumes of food and liquid, the multi-position hinge 165 may allow the hinged lid 160 to be positioned at a greater height above the base 110. This increased clearance may provide ample space for stews, roasts, or other dishes that require longer cooking times and more vertical space. The hinge 165’s ability to lock at different angles may also facilitate sealing the top of the plate and unsealing for easy stirring or ingredient addition during the slow cooking process, helping to maintain consistent temperatures and moisture levels within the cooking chamber.

The interchangeable plates in the multi-function grill may be designed with a secure yet easily removable attachment system utilizing clips and/or other equivalent attachment devices. In some implementations, the base cooking plate 140 and the lid cooking plate 510 may feature integrated clips (not show) along their edges that snap into corresponding receptacles on the grill base 110 and the lid 160, allowing for a firm connection during cooking while enabling quick release for cleaning or plate changes. The attachment mechanism may be designed to accommodate various plate types and thicknesses, ensuring compatibility with the full range of cooking functions offered by the multi-function grill. Of course, other attachment systems are possible. Alternatively, the base cooking plate 140 and the lid cooking plate 510 may be permanently fixed to the grill base 110 and the lid 160, respectively. This configuration may offer advantages such as enhanced stability and simplified construction.

The foldable design of the grill offers significant versatility and storage benefits. When folded, the grill presents a compact form ideal for storage or transport. The unfolded configuration provides an expanded cooking area, enhancing its versatility for different cooking needs. In some cases, the base cooking plate 140, the lid cooking plate 510, and multi-position hinge 165 may allow for a set of additional cooking functions. For example, the grill may be used as a panini press when partially unfolded, with the lid 160 exerting pressure on the food. In other cases, the grill may function as a waffle maker with specialized plates. The multi-position hinge 165 may also enable dual zone cooking, where different temperatures or cooking styles may be applied to each of the base cooking plate 140 and the lid cooking plate 510 simultaneously. Alternative folding designs or mechanisms may include a telescoping hinge for variable height adjustment, or a detachable lid 150 that can be completely removed and used as a separate cooking surface.

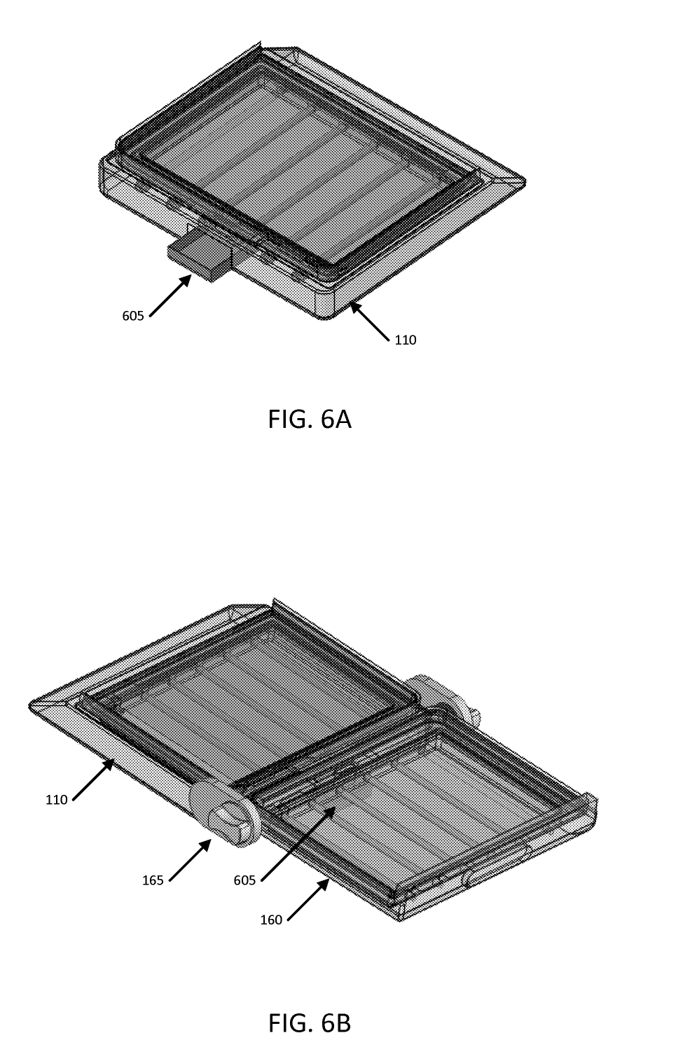

FIGS. 6A and 6B illustrate a grill with a drip tray 605. The grill comprises a base unit and a hinged lid 160 that can be opened to reveal two separate cooking surfaces. In the folded configuration, the grill appears as a compact unit with the lid 160 closed over the base 110. A slidable drip tray 605 protrudes from one side (e.g., the backside) of the grill in this folded state. When the grill is unfolded, the two cooking surfaces are revealed, each with a ribbed surface for grilling. The drip tray 605 is positioned between the two plates, extending outward from the center of the unfolded grill.

The drip tray 605 configuration plays a role in the grill’s functionality and ease of use. In the folded state, the drip tray 605 collects drippings from the single visible cooking surface. When the grill is unfolded, the centrally positioned drip tray 605 is ideally placed to collect drippings from both cooking surfaces simultaneously. This design ensures efficient grease management regardless of the grill’s operational state. The slidable nature of the drip tray 605 allows for easy removal and cleaning, enhancing the overall user experience and maintenance of the grill.

In some implementations, the drip tray 605 may be designed with enhanced functionality for user convenience. The drip tray 605 may be manually slidable, allowing users to easily extend or retract it as desired for cleaning or emptying. Alternatively, the grill may incorporate a mechanical system (not shown) that automatically extends the drip tray 605 when the grill is unfolded. This automated mechanism may be triggered by the unfolding action, utilizing linkages, gears, or other mechanical components to smoothly slide out the drip tray as the grill opens. Such a feature may enhance the user experience by ensuring the drip tray 605 is properly positioned to collect drippings from both cooking surfaces when the grill is in use.

In one embodiment, drip tray 605 may be provided with a spring-loaded lever mechanism (not shown) including a button / slide that is tied to a lever with a pivot point. The lever on the other side of the pivot point then pushes drip tray 605 out when pressed, and pull drip tray 605 back in when not pressed by the lid.

In some cases, the mechanism may also automatically retract the drip tray when the grill is folded, ensuring a compact and tidy configuration for storage or transport. The automatic extension may also serve as a visual indicator that the grill is fully opened and ready for dual-surface cooking. In some cases, the mechanism may allow for both automatic and manual operation, providing users with flexibility in how they interact with the drip tray based on their preferences or specific cooking scenarios.

Alternative drip tray designs may include multiple smaller trays 605 for each cooking surface or a larger, non-slidable drip tray 605 that spans the width of the unfolded grill. In some cases, the drip tray 605 may be integrated into the base of the grill 110 with a pour spout for easy emptying. The placement of the drip tray 605 may also vary, with some designs positioning it at the front of the grill for easier access. However, the central, slidable configuration shown in FIGS. 6A and 6B offer a balance of functionality and convenience, allowing for efficient drip collection in both folded and unfolded states while maintaining a compact profile when the grill is closed.

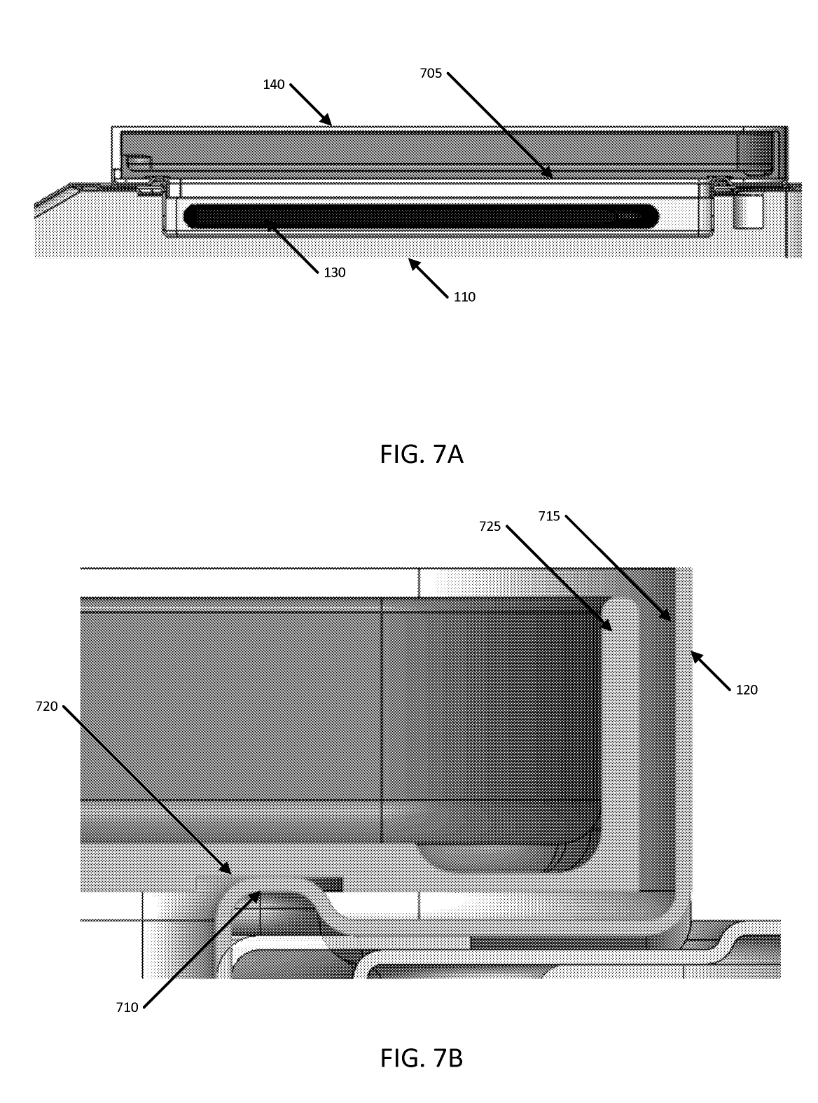

FIGS. 7A and 7B illustrate close-up section views of a heated chamber 705 and seal between a grill plate 140 and reflector 120 in a cooking device. FIG. 7A displays the overall structure, including a grill plate 140 positioned above a heated chamber 705. The heated chamber 705 is located below the grill plate 140 and appears as a recessed area. This heated chamber 705 houses the heating elements 130, which may be either tubular or panel type, depending on the specific configuration of the cooking device. FIG. 7B focuses on the interface between the grill plate 140 and the reflector 120. This magnified view reveals several components that contribute to the sealing mechanism. The grill plate wall 725 forms the upper portion of the grill plate 140, creating the side of the cooking surface. Adjacent to the grill plate wall 725 is the reflector wall 715, a vertical surface extending upward from the reflector 120. This reflector wall 715 ensures that heat from the grill plate wall 725 is reflected back to the grill plate 140, enhancing overall heat efficiency.

At the bottom edge of the grill plate 140, a groove or channel 720 is present. This groove or channel 720 is designed to interface with a protruding section of the reflector 120, referred to as the reflector step 710. The reflector step 710 extends towards the groove or channel 720, creating a tight fit between the two components. This configuration forms a seal that helps contain heat within the heated chamber 705 and prevent heat leakage.

The sealing mechanism between the grill plate 140 and the reflector 120 may be a metal-on-metal contact or, in some cases, may incorporate a compressible material (not shown) such as a silicone element for enhanced sealing properties. The choice of sealing method may depend on factors such as the desired level of heat retention, manufacturing considerations, and maintenance requirements.

The design of the heated chamber 705 and seal plays a role in the cooking device’s performance. By effectively containing heat within the heated chamber 705, the design promotes efficient heat distribution across the cooking surface. This configuration may contribute to more consistent cooking temperatures and potentially reduced energy consumption. Additionally, the sealed design may help maintain moisture levels within the cooking environment, which can be beneficial for certain cooking techniques.

In some cases, alternative sealing mechanisms or chamber designs may be employed. For example, the seal may incorporate a gasket made of heat-resistant materials other than silicone. The shape of the groove or channel 720 and reflector step 710 may be modified to create different sealing geometries. Additionally, the heated chamber may be designed with varying depths or contours to optimize heat distribution for specific cooking applications.

The overall structure of the heated chamber 705 and seal demonstrates a focus on maximizing heat efficiency and providing a secure fit between components. This design approach may contribute to improved cooking performance and energy efficiency in the cooking device.

It is noted that the configuration illustrated in FIGS. 7A and 7B may be similar for both the base unit 110 and the lid unit (not shown) of the multi-function grill. In some implementations, the lid unit may incorporate a mirror image of the heated chamber 705 and sealing mechanism shown in the base unit 110. This symmetrical design may allow for efficient heating and sealing in both the upper and lower cooking surfaces when the grill is closed. The lid unit may feature its own grill plate, reflector, and heating elements, arranged in a similar manner to the base unit 110. The groove and step sealing mechanism may also be present in the lid unit, creating a tight seal when the grill is closed. This dual-chamber configuration may enhance the grill’s versatility, allowing for even heating from both top and bottom, which may be particularly useful for functions such as pressing sandwiches or searing meats. The similarity in design between the base and lid units may also simplify manufacturing processes and potentially allow for interchangeable parts between the two sections.

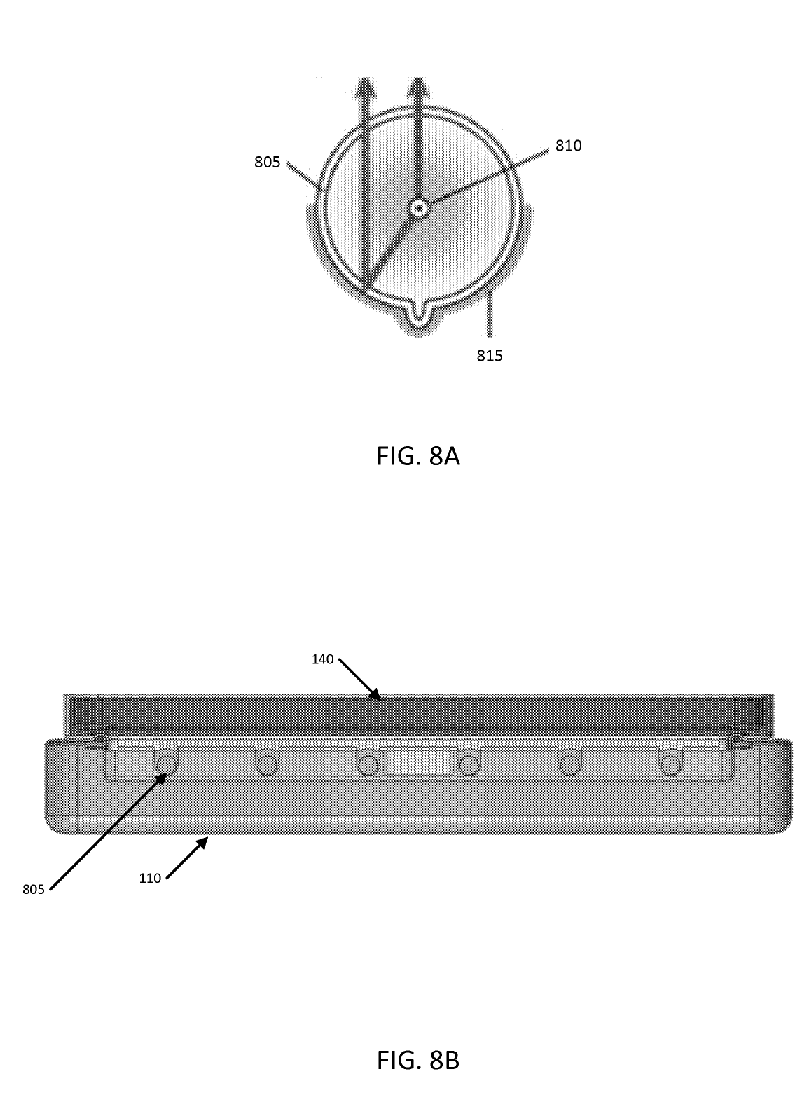

As shown in FIGS. 8A and 8B, the grill base portion 110 may incorporate an infrared heating system to provide efficient and rapid heating of the cooking surface. In some cases, the infrared heating system may comprise one or more infrared heater tubes 805. Each infrared heater tube 805 may include a filament 810 positioned at the center of the infrared heater tube 805. The inner surface of the infrared heater tube 805 may feature a reflective coating 815 designed to direct infrared radiation towards the cooking surface and away from the bottom surface of the reflector.

The infrared heating system may offer several advantages over traditional heating methods. In some cases, the infrared heaters may provide faster heat-up times, allowing the grill to reach cooking temperature more quickly. The directional nature of the infrared radiation, enhanced by the reflective coating inside the heater tubes, may result in more efficient heat transfer to the cooking surface. This efficiency may lead to reduced energy consumption and more precise temperature control.

In some examples, the infrared heating system may allow for rapid heating of the grill surface to high temperatures for searing meat, followed by quick cooling to lower temperatures for continued cooking. This capability may be achieved through the directional nature of the infrared radiation, which efficiently heats the cooking surface while reducing (e.g., minimizing) heat transfer to the base housing and electronics. The ability to quickly adjust temperatures may provide users with greater control over the cooking process and enable versatile cooking techniques within a single grilling session.

In some implementations, multiple infrared heaters may be arranged in parallel beneath the cooking surface. This configuration may allow for even heat distribution across the cooking area. The number and arrangement of infrared heaters may be varied to achieve different heating patterns or to create distinct temperature zones on the cooking surface.

Alternative infrared heating configurations may be employed in some cases. For example, the infrared heaters may be arranged in a grid pattern or in concentric circles to provide different heating profiles. In other implementations, flat panel infrared heaters or ceramic infrared elements may be used instead of or in combination with the tubular heaters. The choice of infrared heating technology and configuration may depend on factors such as the desired heating performance, energy efficiency requirements, and manufacturing considerations.

The infrared heating system may be controlled by a thermostat or electronic control system to maintain the desired cooking temperature. In some cases, the control system may allow for rapid cycling of the infrared heaters, enabling precise temperature adjustments and the ability to quickly reduce heat output when desired. This feature may be particularly useful for tasks such as searing followed by lower-temperature cooking.

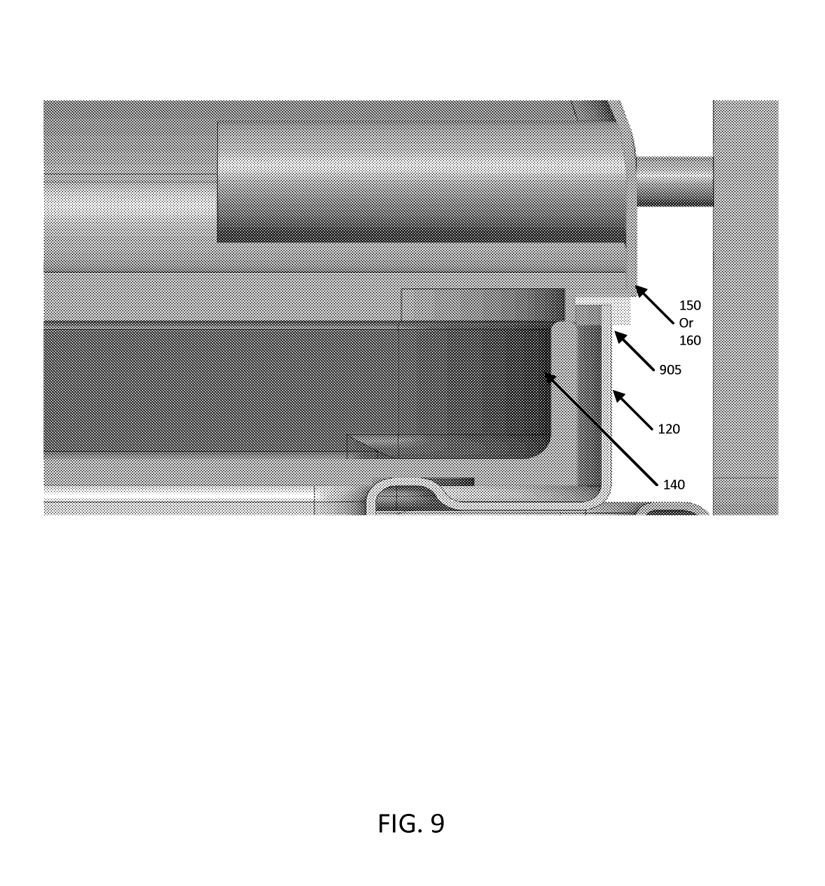

As shown in FIG. 9, the grill assembly may include a sophisticated sealing mechanism designed to enhance heat retention and moisture control during cooking. This sealing system comprises multiple components working in concert to create an efficient cooking environment. At the top of the assembly, a curved lid structure 150 or 160 covers the cooking area. Directly beneath the lid 150 or 160, an optional seal 905 may be implemented to further improve the seal between the lid 150 or 160 and the lower components.

The reflector plate 120, positioned below the optional seal 905, may extend upward to prevent radiant energy loss from the side of the grill plate 140 and contributes to the overall sealing mechanism of the lid 150 or 160 to the reflector plate 120, creating a tight seal that reduces convective heat losses.

When the lid 150 or 160 is closed, these components work together to create a sealed cooking environment. This design offers several advantages. First, it improves heat distribution and retention, allowing for more consistent cooking temperatures and reducing convective heat loss thus reducing energy consumption. Second, it helps to control moisture levels within the cooking chamber, which can be beneficial for certain cooking techniques or recipes. The optional seal 905 provides an additional layer of insulation and sealing, which may be particularly beneficial for slow-cooking or moisture-sensitive dishes.

In one embodiment, optional seal 905 may be made of silicon.

Alternative sealing designs or materials may be considered for this system. For instance, in some cases, a metal-to-metal seal between the reflector plate 120 and lid 150 or 160 may be sufficient without the need for optional seal 905. In other implementations, different heat-resistant materials such as fiberglass or ceramic fiber may be used for the optional seal 905. The specific choice of sealing mechanism and materials may depend on factors such as the intended cooking applications, manufacturing considerations, and durability requirements.

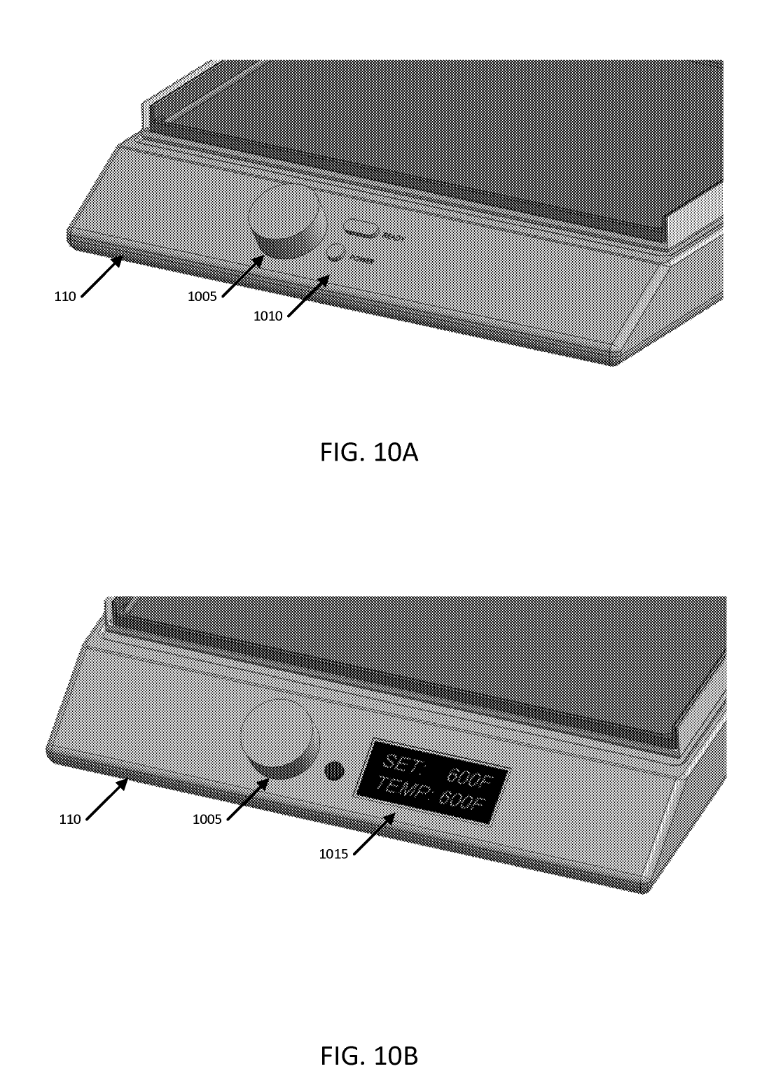

As shown in FIGS. 10A and 10B, the grill may feature various control panel configurations to accommodate different user preferences and cooking needs. In some cases, the control panel may include a basic configuration with a knob 1005 for temperature adjustment and two smaller circular elements 1010 that may serve as indicator lights or additional control buttons. This simple design allows for straightforward operation and temperature control.

In other cases, the grill may incorporate a more advanced control panel configuration. This configuration may maintain the large circular knob but replace the smaller elements with a digital display 1015. The digital display may show temperature information, including the set temperature and the current temperature of the cooking surface. A small circular indicator, which may be an LED light, may be included to provide additional visual feedback to the user.

In embodiments, the grill may include a fan (not shown) to cool the control panel and sensitive components, such as displays that require low operating temperatures (e.g., LCDs with touch Overlays, OLEDs, AMOLEDs, and MicroLEDs).

The addition of fans to cool control panel is not illustrated but may be added if sensitive control components are used

The grill may also feature a temperature probe interface (not shown) to enhance cooking precision. This interface may allow users to connect a temperature probe to the grill, enabling more accurate temperature readings of the food being cooked. In some cases, the temperature probe may help set cooking temperatures based on user instructions.

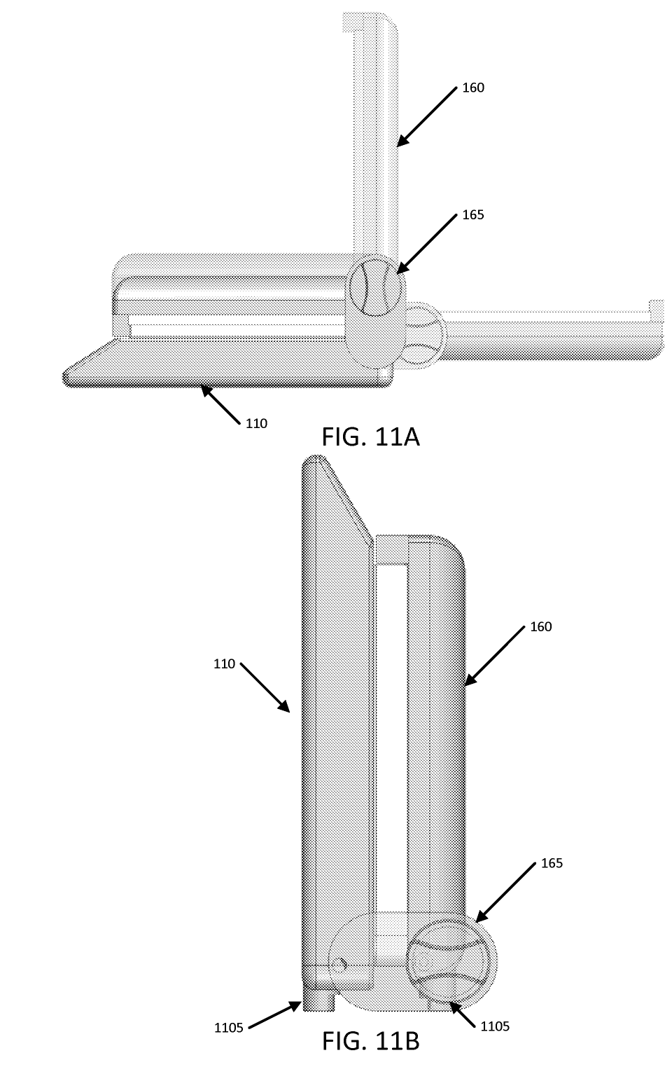

FIGS. 11A and 11B illustrate orthogonal side views of a grill in various positions and a vertical storage position. The figure demonstrates the grill’s versatility and space-saving design.

FIG. 11A shows the grill in multiple operational positions. The grill may comprise a base unit 110 and a hinged lid 160 connected by a central hinge mechanism 165. In the folded position, the hinged lid 160 may be closed over the base unit 110. The raised position may display the hinged lid 160 partially open at a relatively flat angle, which may be suitable for cooking items such as paninis. The open position may demonstrate the hinged lid 160 fully extended vertically. The unfolded position may reveal an extension of the cooking surface to produce two cooking surfaces.

FIG. 11B presents the grill in its vertical storage position. In this configuration, the grill may stand upright, with the hinged lid 160 and base unit 110 aligned vertically. Feet 1105 may be visible at the bottom, potentially providing stability when the grill is stored in this space-saving orientation. The unit may be hinged such that the weight of the base 110 and hinged lid 160 are biased towards one another, which may help the grill stay closed when in the vertical position. This design may avoid the need for additional components such as springs.

The hinge mechanism 165 may be multi-functional, potentially allowing for various lid positions during operation and facilitating the transition to vertical storage. This design may enhance the grill’s versatility, enabling it to adapt to different cooking needs and storage constraints.

The grill’s ability to transform between operational and storage configurations may demonstrate a focus on user convenience and space efficiency. The various positions may offer flexibility in cooking methods, while the vertical storage option may allow for compact storage in limited spaces.

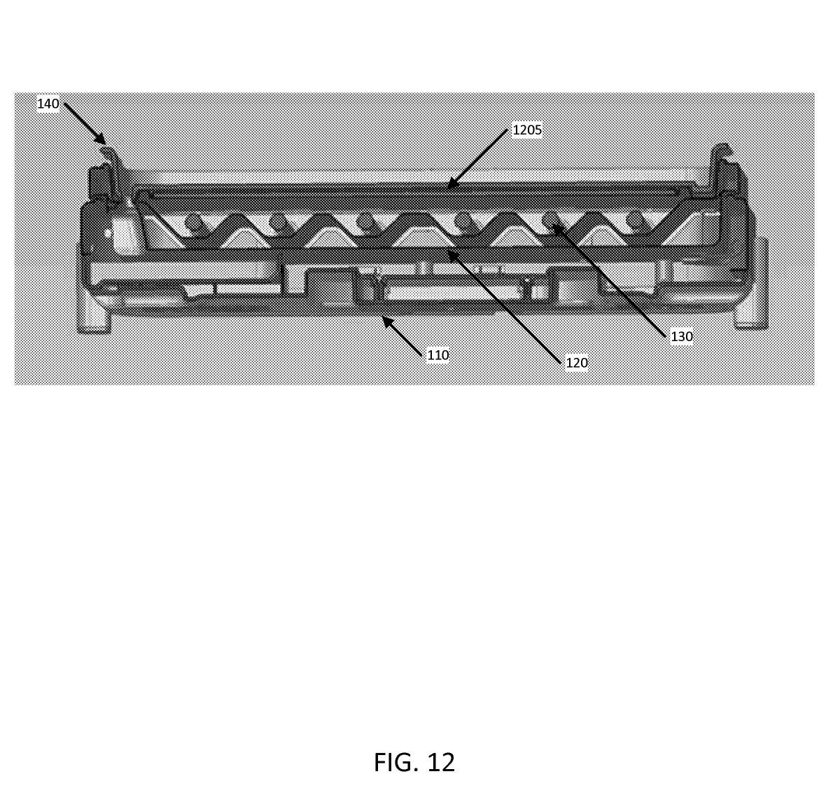

Referring to FIG. 12, in one embodiment, the grill base portion 110 may include a transparent protection plate 1205 between the heating elements 130 and grill plate 140. In one embodiment, separating plate 1205 may be a glass plate; other materials, including, for example, fused quartz, fused silica, transparent ceramics (e.g., single crystal Aluminum Oxide), Aluminum Oxynitride, etc. may be used as is necessary and/or desired. Transparent protection plate 1205 may not only provide a surface between heating elements 130 and grill plate 140, but it may also provide a protective barrier to protect the infrared heaters from grease and water and potential impact from customers during cleaning.

A number of implementations have been described. Nevertheless, it will be understood that various modifications may be made without departing from the spirit and scope of the disclosure. Accordingly, other implementations are within the scope of the following claims.

What is claimed is:

1. A multi-function grill, comprising:
a base unit;
a grill plate positioned on the base unit;
a reflector disposed beneath the grill plate, the reflector and the grill plate forming a sealed heated chamber between the reflector and the grill plate;
at least one heating element positioned within the sealed heated chamber; and
a control panel for adjusting cooking temperature.

2. The multi-function grill of claim 1, further comprising a lid unit.

3. The multi-function grill of claim 2, wherein the lid unit is attached to the base unit by a hinge mechanism, the base unit and the lid unit attached to the base unit by the hinge mechanism are configured to accommodate a plurality of removable grill plates each having different physical dimensions.

4. The multi-function grill of claim 1, wherein the grill plate comprises a groove along its perimeter and the reflector comprises a step, the groove and the step configured to engage with each other to form the sealed heated chamber.

5. The multi-function grill of claim 1, wherein the at least one heating element comprises at least one of an infrared heating element, a halogen heating element or a resistive heating element.

6. The multi-function grill of claim 1, wherein the reflector comprises a grill seat configured to support the grill plate at a predetermined distance from the at least one heating element, and the base unit comprises a reflector seat configured to support the reflector.

7. The multi-function grill of claim 1, wherein the at least one heating element comprises an infrared heating element comprising a tubular structure with a filament positioned at a center and an inner surface coated with a reflective material, the reflective material configured to direct infrared radiation towards the grill plate.

8. The multi-function grill of claim 1, wherein an underside surface of the grill plate facing the at least one heating element comprises a radiation absorbent material.

9. The multi-function grill of claim 1, further comprising a transparent protection plate between the least one heating element and the grill plate.

10. A multi-function grill, comprising:
a base unit comprising:
a grill plate positioned on the base unit,
a reflector disposed beneath the grill plate, the reflector and the grill plate forming a sealed heated chamber between the reflector and the grill plate, and
at least one heating element positioned within the sealed heated chamber;
a lid unit comprising:
a lid grill plate positioned on the lid,
a lid reflector disposed beneath the lid grill plate, the lid reflector and the lid grill plate forming a lid sealed heated chamber between the lid reflector and the lid grill plate, and
at least one lid heating element positioned within the lid sealed heated chamber; and
a control panel for controlling the at least one heating element and the at least one lid heating element to adjust cooking temperature.

11. The multi-function grill of claim 10, wherein the lid unit is attached to the base unit by a hinge mechanism, the lid unit attached to the base unit by the hinge mechanism configured to accommodate a plurality of removable grill plates each having different physical dimensions.

12. The multi-function grill of claim 11, wherein the plurality of removable grill plates comprise at least one of waffle making plates, panini pressing plates and slow cooking plates.

13. The multi-function grill of claim 11, wherein the plurality of removable grill plates are attached to the base unit and lid unit by respective clip mechanisms.

14. The multi-function grill of claim 10, wherein the grill plate and the lid grill plate each comprise a groove along their perimeter and the reflector and lid reflector each comprise a step, the grooves and steps configured to engage with each other to form the sealed heated chamber and the lid sealed heated chamber.

15. The multi-function grill of claim 14, wherein the grooves of the grill plate and the lid grill plate and the steps of the reflector and lid reflector create metal-to-metal seals when engaged.

16. The multi-function grill of claim 10, wherein the at least one heating element and the at least one lid heating element are each at least one of an infrared heating element, a halogen heating element or a resistive heating element.

17. The multi-function grill of claim 10, wherein the reflector comprises a grill seat configured to support the grill plate at a predetermined distance from the at least one heating element, and the base unit comprises a reflector seat configured to support the reflector, and wherein the lid reflector comprises a lid grill seat configured to support the lid grill plate at a predetermined distance from the at least one lid heating element, and the lid unit comprises a reflector seat configured to support the lid reflector.

18. The multi-function grill of claim 10, wherein the at least one heating element and the at least one lid heating element each comprise an infrared heating element comprising a tubular structure with a filament positioned at a center and an inner surface coated with a reflective material, the reflective material configured to direct infrared radiation towards the grill plate and the lid grill plate respectively.

19. The multi-function grill of claim 10, wherein an underside surface of the grill plate facing the at least one heating element and an underside surface of the lid grill plate facing the at least one lid heating element comprise a radiation absorbent material.

20. The multi-function grill of claim 10, further comprising a transparent protection plate between the least one heating element and the grill plate.
